(19) United States
(12) Patent Application Publication
(10) Pub. No.: US 2020/0264695 A1
(43) Pub. Date: Aug. 20, 2020

(54) A CLOUD-BASED SYSTEM AND METHOD FOR CREATING A VIRTUAL TOUR

(71) Applicant: EYEXPO TECHNOLOGY CORP., Vancouver (CA)

(72) Inventors: Thompson SANJOTO, Vancouver (CA); Ashton Daniel CHEN, Vancouver (CA); Dong LIN, Vancouver (CA); Ben HO, Vancouver (CA); Yiting LONG, Richmond (CA); Xinhui QIU, Vancouver (CA); Pan PAN, Vancouver (CA)

(73) Assignee: EYEXPO TECHNOLOGY CORP., Vancouver, BC (CA)

(21) Appl. No.: 16/652,009

(22) PCT Filed: Jun. 20, 2018
(86) PCT No.: PCT/CA2018/050748

§ 371 Date: Mar. 27, 2020

Related U.S. Application Data
(60) Provisional application No. 62/565,251, filed on Sep. 29, 2017.
(60) Provisional application No. 62/565,217, filed on Sep. 29, 2017.

(51) Int. Cl. G06F 3/01; G06F 3/0481; G02B 27/01; G06T 19/00; G06T 19/20; H04N 5/232

(52) U.S. Cl. CPC G06F 3/011; G06F 3/04815; G02B 27/0172; H04N 5/23238; G06T 19/20; G06T 19/006; G06T 19/003

(57) ABSTRACT

A Cloud-based method, system and computer-readable medium of creating a virtual tour is described. The method comprises allowing a user to upload images for stitching of a 360 panorama image; creating a virtual tour based on the 360 panorama image; and allowing the user to edit the virtual tour by embedding an object for the user to interact with, when the virtual tour is viewed with a Virtual Reality (VR) headset.

### CROSS REFERENCE TO RELATED APPLICATIONS

This application claims the benefit of priority based on U.S. Application No. 62/565,251, filed on Sep. 29, 2017, entitled, “SYSTEM AND METHOD FOR CREATING A VIRTUAL REALITY ENVIRONMENT”, and U.S. Application No. 62/565,217, filed on Sep. 29, 2017, entitled, “MOBILE DEVICE-ASSISTED CREATION OF VIRTUAL REALITY ENVIRONMENT”, the disclosure of all of which is hereby incorporated by reference herein.

### TECHNICAL FIELD

The present disclosure relates to a virtual tour creation tool and more particularly, to Cloud-based systems, methods, and computer-readable media for creating and building a virtual tour.

### BACKGROUND

There has been increasing interest in providing virtual tour creation tools, which enable users to create and customize computer-generated environments that simulate user presence in the real world. The direction virtual tours are heading in the industry is to allow content creators to edit the virtual environment and to enable interaction of user embedded elements, creating a fully immersive content environment.

Current solutions of online-based virtual tour builders on the market are generally built on a known platform which acts as a development kit with a number of pre-created functions. The virtual tour building solutions built on such a platform have limited abilities for content creators to embed objects into the 360 panorama background. Often the created virtual tours are optimized for viewing in a 2D web browser environment, but when viewed in the Virtual Reality (VR) mode using VR headsets, the embedded elements are removed as they are not supported in the VR environment.

In addition, a majority of the solutions require content creators to upload pre-created 360 panorama images for creation of the virtual tours.

Therefore there exists a need for an improved system and method for creating and customizing virtual tours.

### SUMMARY

The following presents a summary of some aspects or embodiments of the disclosure in order to provide a basic understanding of the disclosure. This summary is not an extensive overview of the disclosure. It is not intended to identify key or critical elements of the disclosure or to delineate the scope of the disclosure. Its sole purpose is to present some embodiments of the disclosure in a simplified form as a prelude to the more detailed description that is presented later.

In accordance with an aspect of the present disclosure there is provided a cloud-based method of creating a virtual tour. The method includes allowing a user to upload images for stitching of a 360 panorama image; creating a virtual tour based on the 360 panorama image; and allowing the user to edit the virtual tour by embedding an object for the user to interact with, when the virtual tour is viewed with a Virtual Reality (VR) headset.

In accordance with another aspect of the present disclosure there is provided a non-transitory computer readable memory recorded thereon computer executable instructions that when executed by a processor perform a cloud-based method of creating a virtual tour. The method includes allowing a user to upload images for stitching of a 360 panorama image; creating a virtual tour based on the 360 panorama image; and allowing the user to edit the virtual tour by embedding an object for the user to interact with, when the virtual tour is viewed with a Virtual Reality (VR) headset.

### BRIEF DESCRIPTION OF THE DRAWINGS

These and other features of the disclosure will become more apparent from the description in which reference is made to the following appended drawings.

FIG. 1 is an exemplary AWS infrastructure architecture for implementing the Cloud-based virtual tour builder in accordance with an embodiment of the disclosure.

FIG. 2 is a flow diagram for using the Cloud-based virtual tour builder for creating a 360 virtual tour or 360 panorama image, according to an embodiment of the disclosure.

FIG. 3A is an example of a scene menu which shows the panorama images as part of a virtual tour, in accordance with an embodiment of the disclosure.

FIG. 3B is an example of an asset library which stores 360 panorama images, 3D models and 3D photos, in accordance with an embodiment of the disclosure.

FIG. 3C is an example of the “Editor” page interface, according to an embodiment of the disclosure.

FIG. 3D is an example of the user interface for adding a hotspot to a scene of a virtual tour, according to an embodiment of the disclosure.

FIG. 3E is an example of the user interface for adding a teleport and setting a default view, according to an embodiment of the disclosure.

FIG. 3F is an example of the user interface for embedding a 3D model to a scene of a virtual tour, according to an embodiment of the disclosure.

FIG. 3G is an example of the user interface for adjusting the settings of the embedded 3D model, according to an embodiment of the disclosure.

FIG. 3H is an example of the virtual tour with the embedded 3D model in preview mode, according to an embodiment of the disclosure.

FIG. 3I is an example of the virtual tour with the embedded 3D model in WebVR mode, according to an embodiment of the disclosure.

FIG. 3J is an example of the user interface for adding one or more panorama images to a virtual tour, according to an embodiment of the disclosure.

FIG. 3K is an example of the user interface for adding the images for 360 panorama stitching, according to an embodiment of the disclosure.

FIG. 3L is an example of the user interface for selecting a sky image, according to an embodiment of the disclosure.

FIG. 3M is an example of the user interface for selecting two ground images, according to an embodiment of the disclosure.

FIG. 3N is an example of the user interface for identifying the orientation of the ground images, according to an embodiment of the disclosure.

FIG. 3O is an example of the user interface for providing the specifications of the 360 panorama stitching, according to an embodiment of the disclosure.

FIG. 3P is an example showing the stitched panorama image, according to an embodiment of the disclosure.

FIG. 4 is a Cloud-based method of creating a virtual tour, according to one embodiment of the disclosure.

FIG. 5 is a Cloud-based method of 360 panorama image stitching, according to one embodiment of the disclosure.

### DETAILED DESCRIPTION OF THE INVENTION

A general aspect of the disclosure relates to providing a Cloud-based virtual tour creation and building tool that improves and enhances functionality and user interaction. Another aspect of the disclosure relates to a Cloud-based virtual tour creation and building tool that supports creating of 360 panorama images based on images taken from a digital camera. The virtual tour creation and building tool may be referred to as the virtual tour builder.

The described virtual tour builder provides the content creators with a simple to use Cloud-based tool that streamlines virtual tour creation and editing process and reduces the time required to build and share their immersive content with the world.

According to various embodiments, the described virtual tour builder enables users to create an end-to-end virtual tour on a single platform. In one implementation, the virtual tour builder is based on the Aframe.io platform.

Some embodiments of the virtual tour builder allow the content creator to embed 2D and/or 3D elements into a virtual tour. The embedded 2D and/or 3D objects are fully interactive in that when the virtual tour is viewed with the Virtual Reality (VR) headsets, the user is able to move the embedded object in different directions using control elements or interface associated with VR headsets. Such control elements or interface can include but not limited to a controller coupled to the VR headset, one or more buttons mounted on the VR headset or device, and/or by way of voice or visual commands.

According to some embodiments of the disclosure, the virtual tour builder provides a Cloud-based solution to create 360 panorama images by stitching images provided by the content creator.

It will be apparent, that the present embodiments may be practiced without some or all of the specific details. The other instances, well known process operations have not been described in detail in order not to unnecessarily obscure the present embodiments.

A user may use a computing device for purposes of interfacing with a computer-generated, VR environment. Such a computing device can be, but not limited to, a personal computer (PC), such as a laptop, desktop, etc., or a mobile device, such as a Smartphone, tablet, etc. A Smartphone may be, but not limited to, an iPhone running iOS, an Android running the Android operating system, or a Windows phone running the Windows operating system. The VR environment can be viewed within a 2D web browser environment running on a computing device with standard specifications in the form of a web page.

The WebVR mode, or VR mode, refers to the mode when the generated VR environment can be viewed with a supporting VR headset device.

Majority of the existing solutions of online-based virtual tour builders are based on a software development kit called KRPano. KRPano provides pre-built function blocks ready for use by developers, however it has limitations when used to embed objects into the 360 panorama background. The created virtual tours are optimized to view in a 2D web browser environment, but when viewed in the VR mode the embedded objects are removed as they are not supported in the VR environment.

In addition, the existing solutions of virtual tour builders usually require content creators to upload pre-created 360 panorama images as they do not support “creating” 360 panorama images based on original photos taken by the user.

The virtual tour builder according to various embodiments of the disclosure is based on the Aframe.io framework, which is a pure web-based framework for building virtual reality experiences. The platform is based on top of Hypertext Markup Language (HTML) allowing creation of VR content with declarative HTML that works across mixed platforms, such as desktops, smartphones, headsets, etc.

The virtual tour builder based on the Aframe.io framework supports various VR headsets or devices, such as but not limited to Vive™, Rift™, Windows™ Mixed Reality, Daydream™, Gear VR™, Cardboard™ and etc. In other words, viewers can experience full immersion with these devices from content created by the virtual tour builder according to various embodiments of the disclosure.

The virtual tour builder according to various embodiments of the disclosure allows the content creators to embed 3D elements or objects in the form of GL Transmission Format (glTF) files or other 3D object file types, which enables easy publishing of the generated 3D content, scenes, assets, etc.

Together with the technology stack Hugins, the virtual tour builder according to various embodiments of the disclosure is configured to produce a 360 panorama image from a set of original photos uploaded by the content creator.

From a backend perspective, the entire Cloud-based virtual tour builder is hosted on a Cloud computing platform such as the Amazon web services (AWS), AliCloud, etc. The solution is built to scale, and certain services within the Cloud computing platform are utilized to provide scalability.

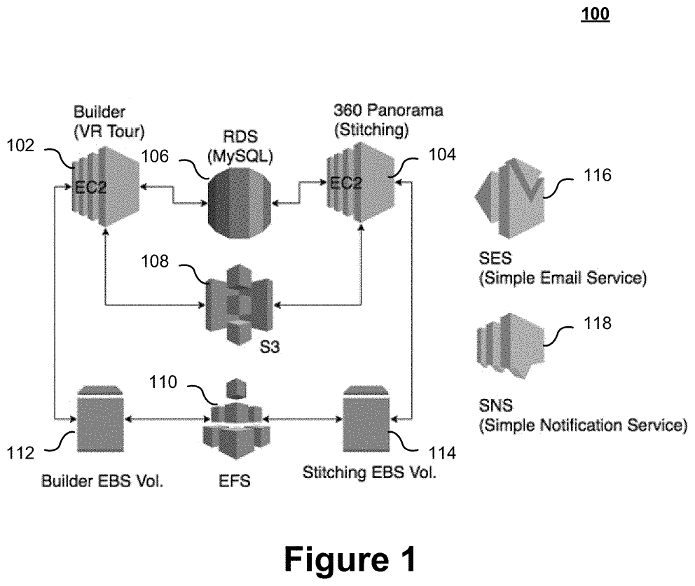

FIG. 1 illustrates an exemplary AWS infrastructure architecture 100 for implementing the Cloud-based virtual tour builder, in accordance with an embodiment of the disclosure.

The AWS architecture 100 for implementing the Cloud-based virtual tour builder involves two AWS Elastic Cloud Computing (EC2) virtual machines 102, 104, one 102 for hosting the VR tour builder, and the other one 104 for hosting the 360 panorama image stitching. All panorama images, or images that are uploaded through the virtual tour builder are stored in an AWS Simple Storage Service (S3) object storage 108.

The virtual servers access a Relational Database Service (RDS) 106 which is the virtual server providing a MySQL database for operational data services. Elastic File System (EFS) 110 is the local storage to the virtual server used to connect the virtual tour builder EC2 102 and the 360 panorama stitching EC2 104, through a builder Elastic Block Store (EBS) volume 112 and a stitching EBS volume 114. This way, the builder EC2 102 and the 360 panorama stitching EC2 104 can be seen by the application as one virtual server. The Cloud-based solution also utilizes simple email service (SES) 116 for sending emails through the virtual tour builder; and simple notification service (SNS) 118 for sending text messages through the virtual tour builder.

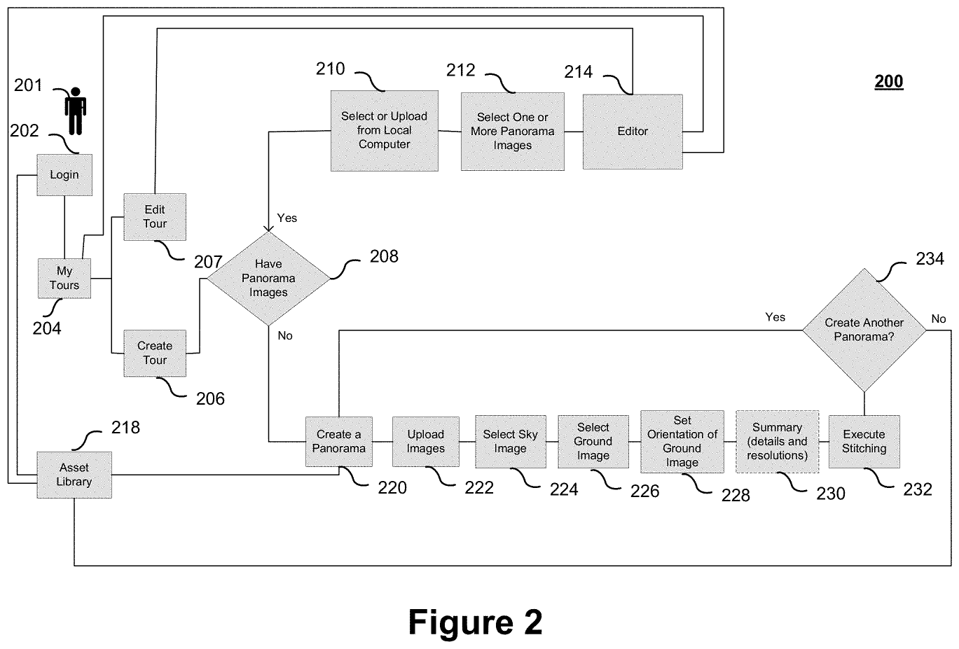

FIG. 2 is a flow diagram 200 using the virtual tour builder for creating or editing a 360 virtual tour, and for creating or editing a 360 panorama image, according to one embodiment of the disclosure.

A content creator 201 can login 202 into the virtual tour builder using their email address, mobile number, or through third party logins such as social media accounts such as Facebook™, Wechat™, etc.

Once logged in, the content creator 201 can access a “My Tours” page 204 for available virtual tours associated with the user account. “My Tours” page 204 can provide a list of all virtual tours that exist for the user account. Users have the options to create 206 a tour or edit 207 a virtual tour from the page. The users can also preview, or delete any virtual tours on the page. When the virtual tour is to be edited, the content creator 201 enters into the “Editor” page 214, as will be explained in more detail below.

The virtual tours are grouped into public and private virtual tours. Public virtual tours are viewable by anyone and each have a unique external link that can be shared; and private virtual tours are not viewable by the public and only accessible by the content creator. On the “My tours” page 204, users can set a virtual tour to be private or public. Users are also able to share public virtual tours via QR Code, WeChat, embed Code, public Uniform Resource Locator (URL) link, etc. Users are able to update their usernames, phone or email addresses, change passwords and set their language preference settings.

In the context of the disclosure, the computer-generated, virtual tour environment can be, but not limited to, a virtual tour of a geographic location or site (such as an exhibition site, a mining site, a theme park, etc.), a real estate property, a simulation of a real life experience such as a shopping experience, a medical procedural, etc.

The generated virtual tour can be shared and displayed in the other computing devices. For example, the virtual tour can be shared via a link, e.g., a web link, representing the generated virtual tour with other computing devices and the virtual tour can be viewed by other users using the link, either in the web browser environment, or in the VR mode with a supporting VR device.

When the computing device is a mobile device such as a Smartphone, the virtual tour builder according to some embodiments of the description can be optimized for the mobile environment, where the virtual tour created can be shared through a web link and other user can view it using a web browser of their own device. Considering the graphics processing unit (GPU) of an average Smartphone would have difficulties rendering such high-resolution images along with all the possible embedded multi-media UI/UX, the generated virtual tour can have a mobile version with a reduced resolution and optimized data types for the UI/UX. This also reduces the amount of loading time and data usage, which significantly improves the overall user experience.

For each virtual tour on the “My tours” page 204, the user can access a scene menu which allows the user to see all panorama images (each panorama image in a virtual tour referred to as a “scene”) that are part of the virtual tour in a single overlay modal window. The user can navigate from the scene menu to any particular scene.

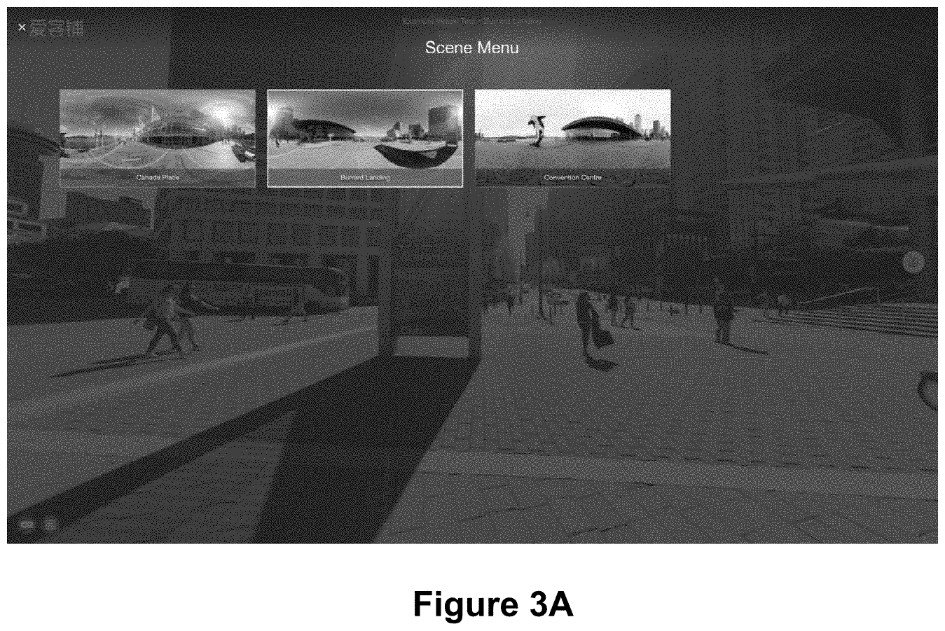

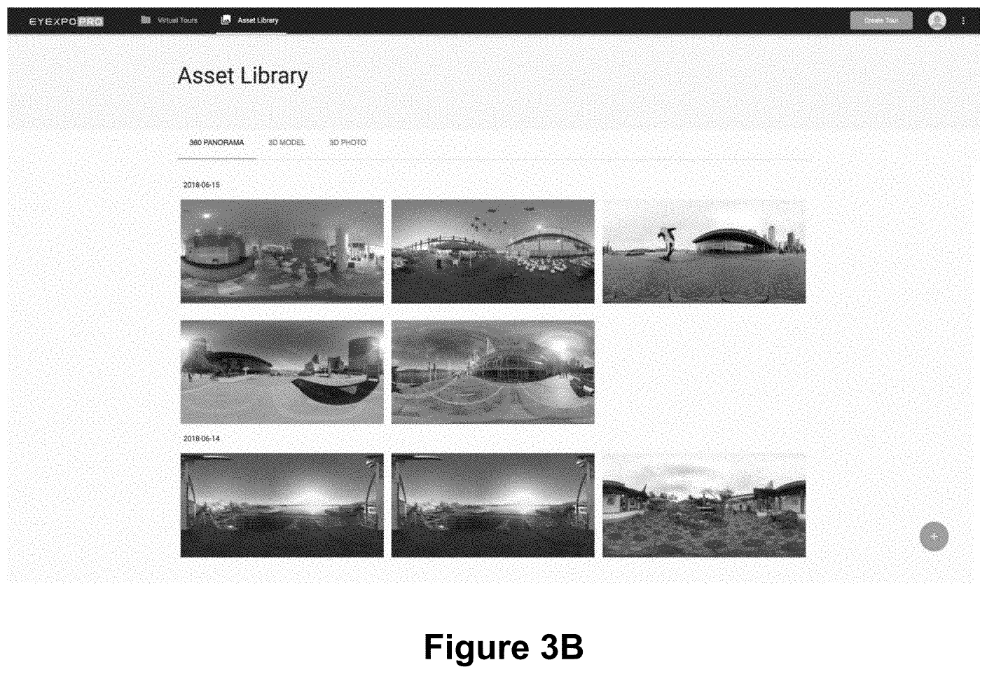

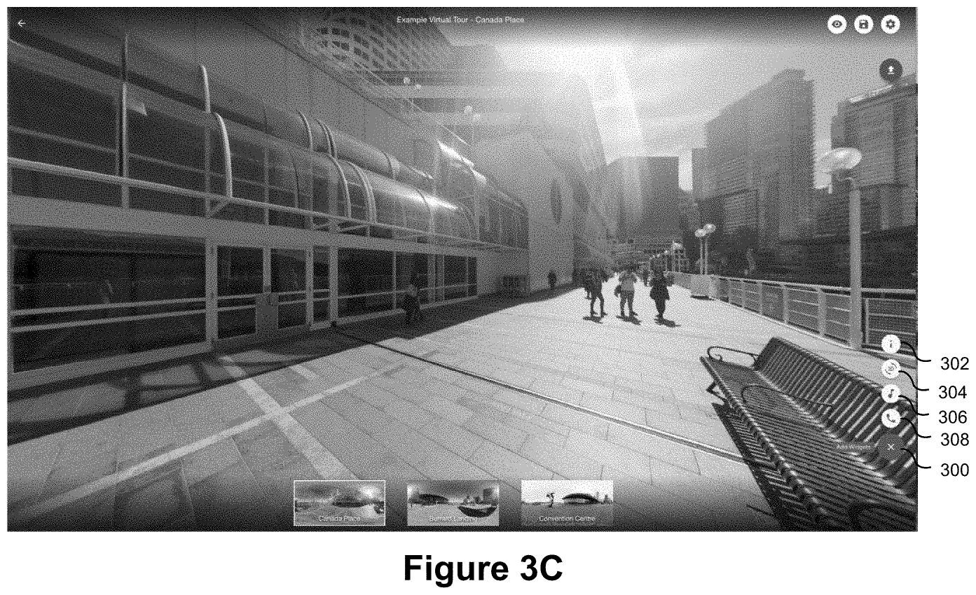

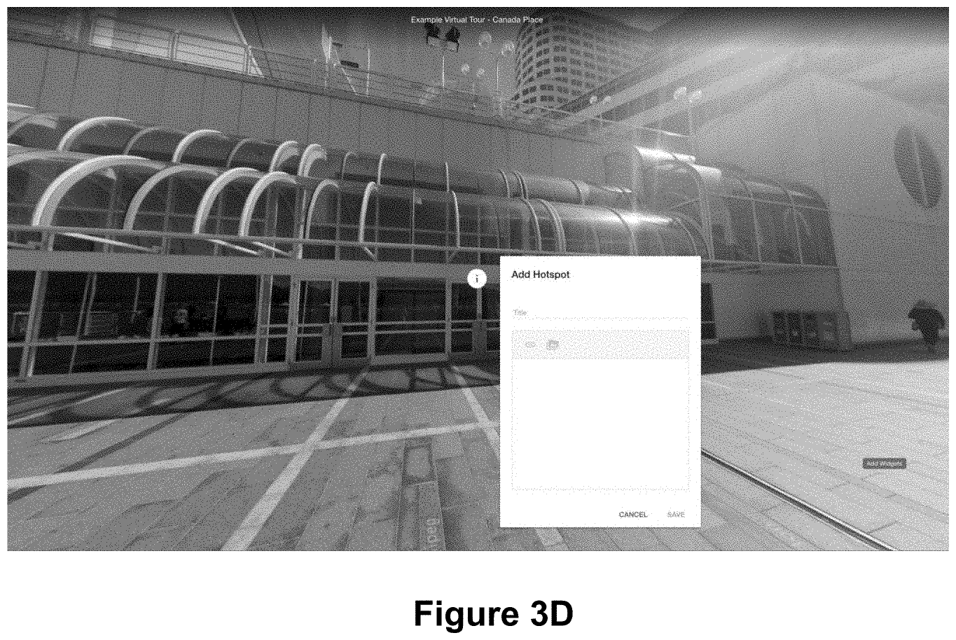

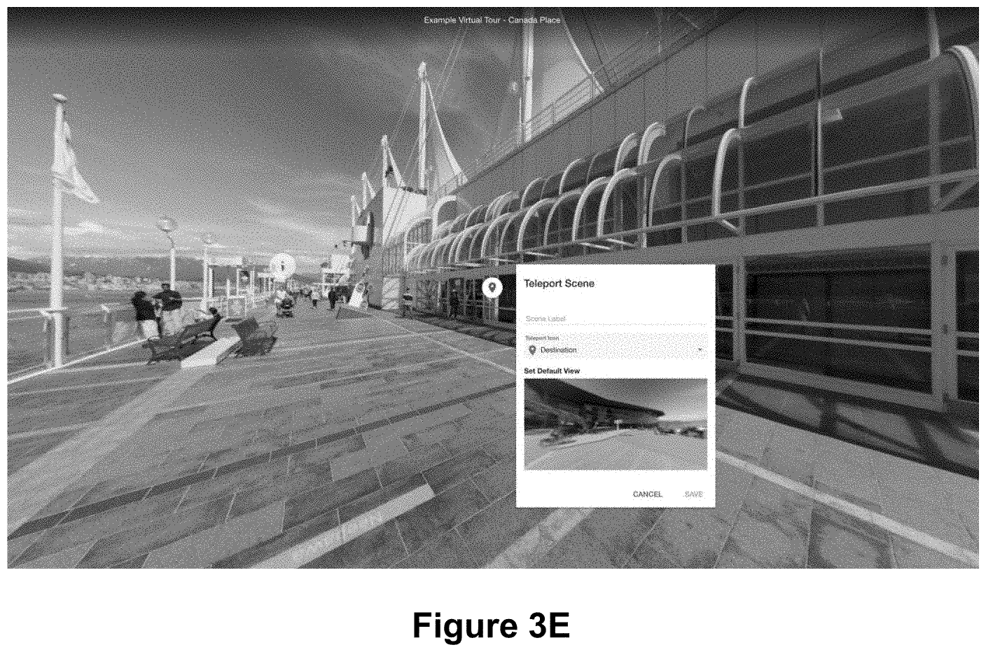

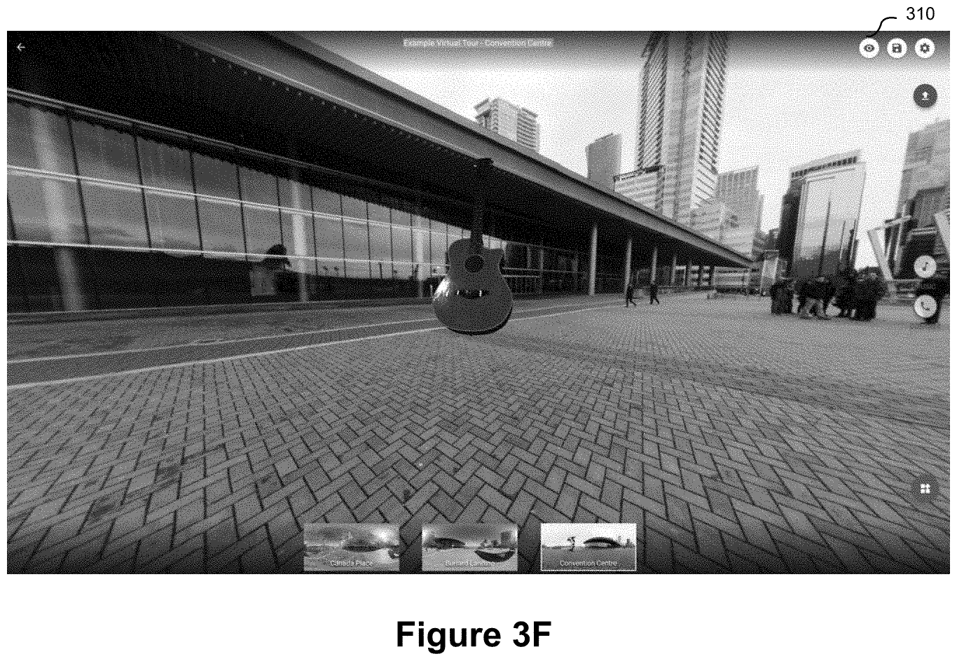

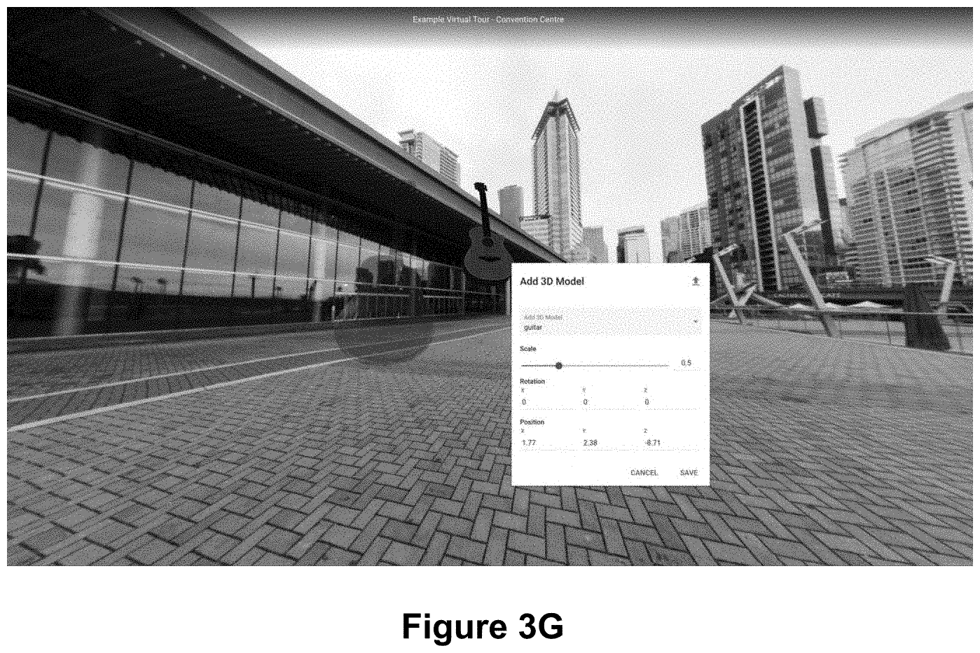

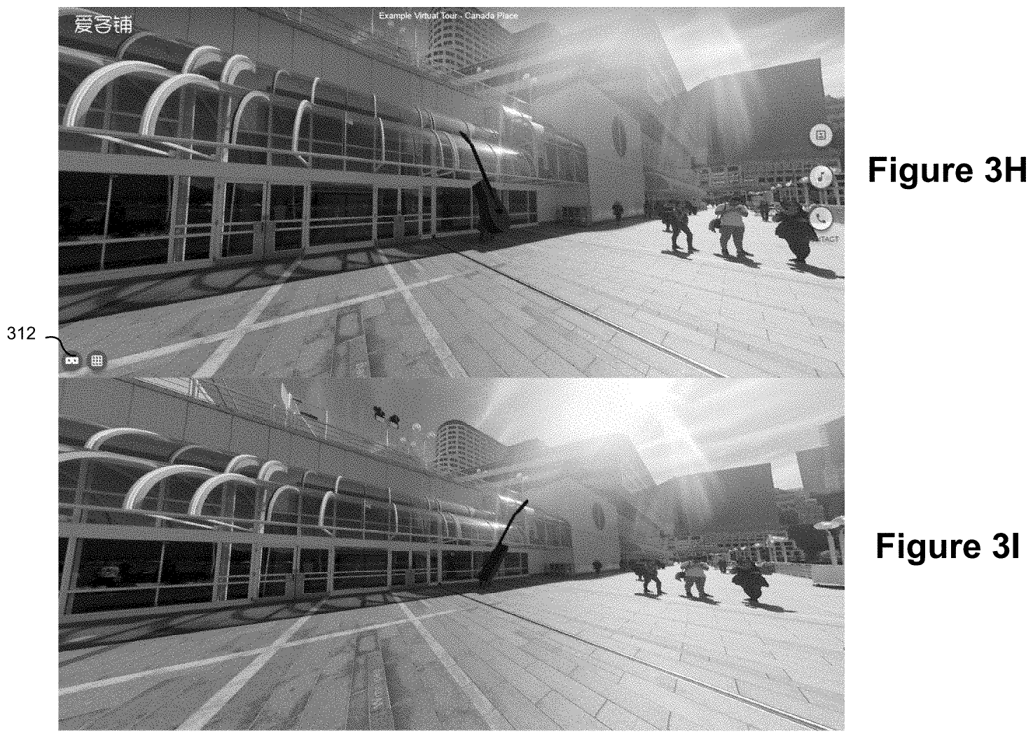

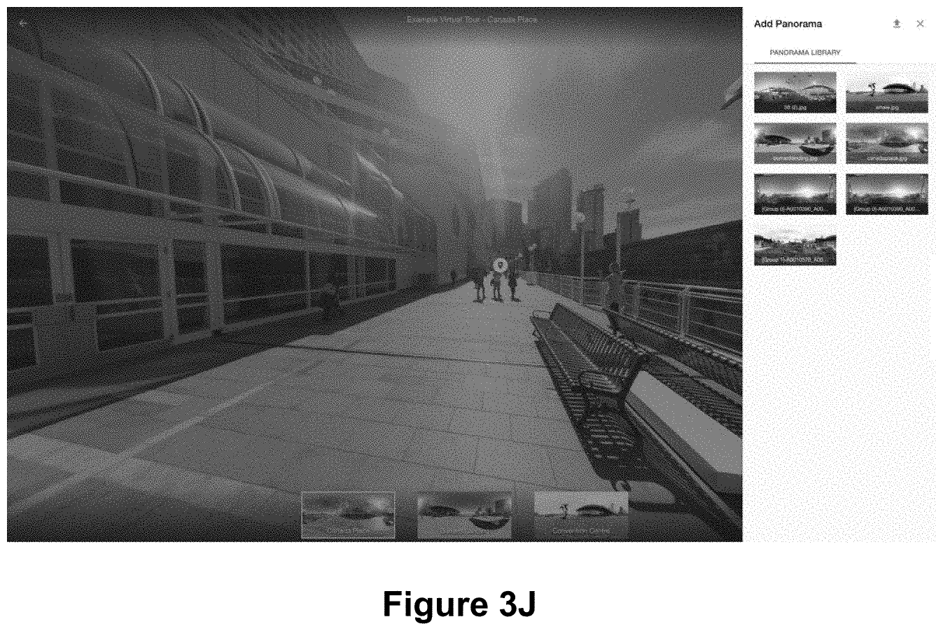

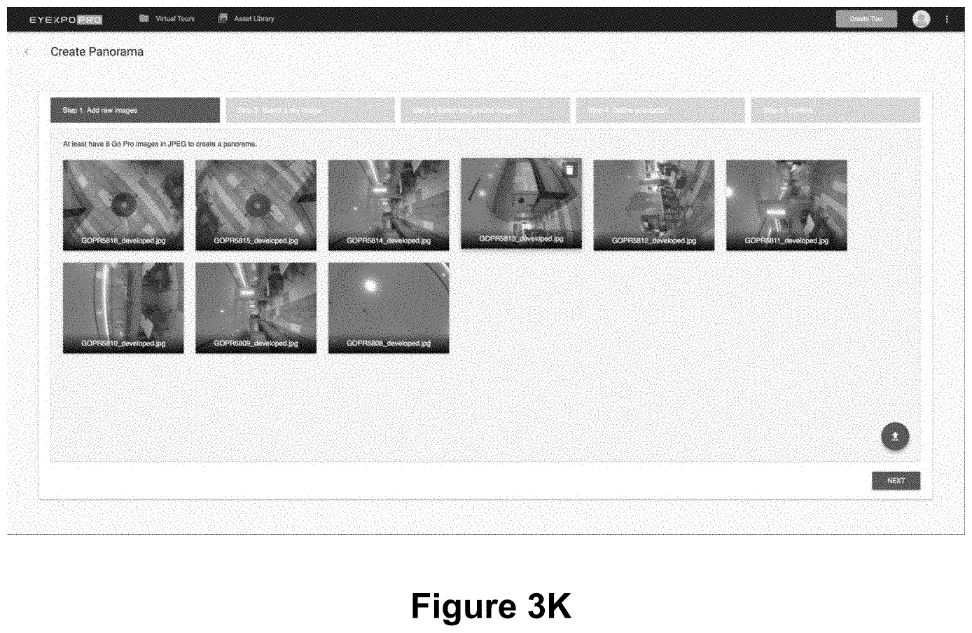

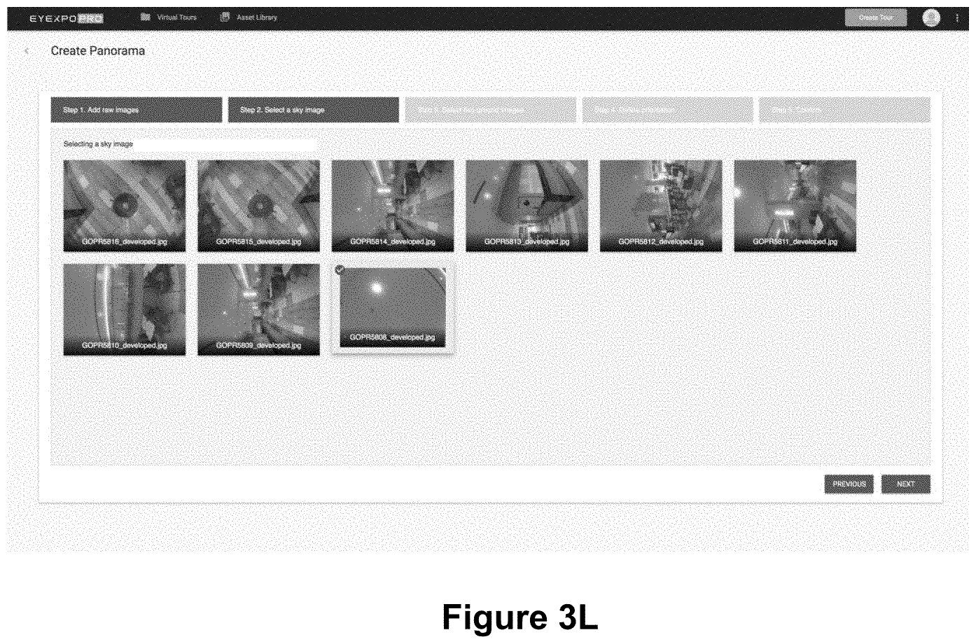

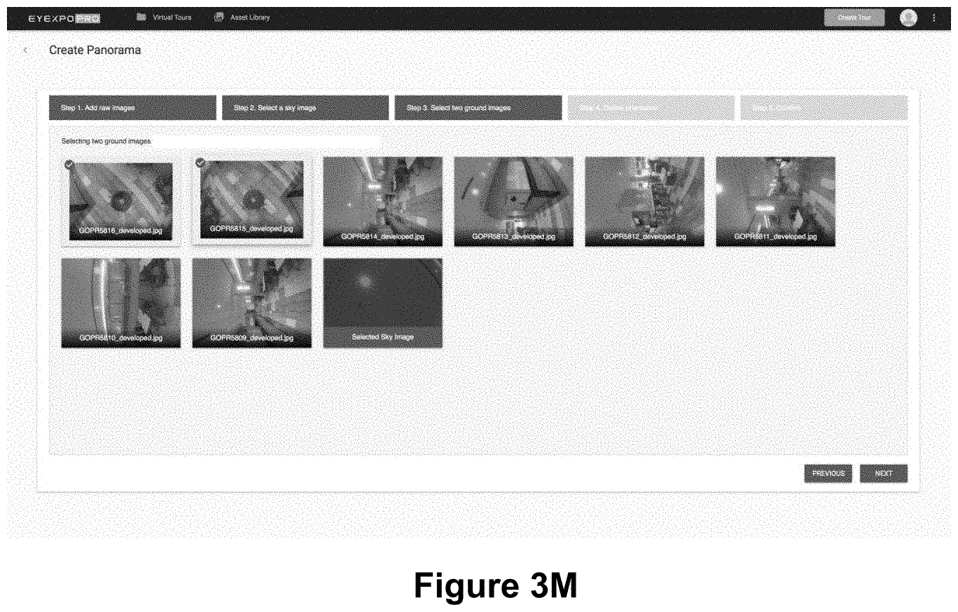

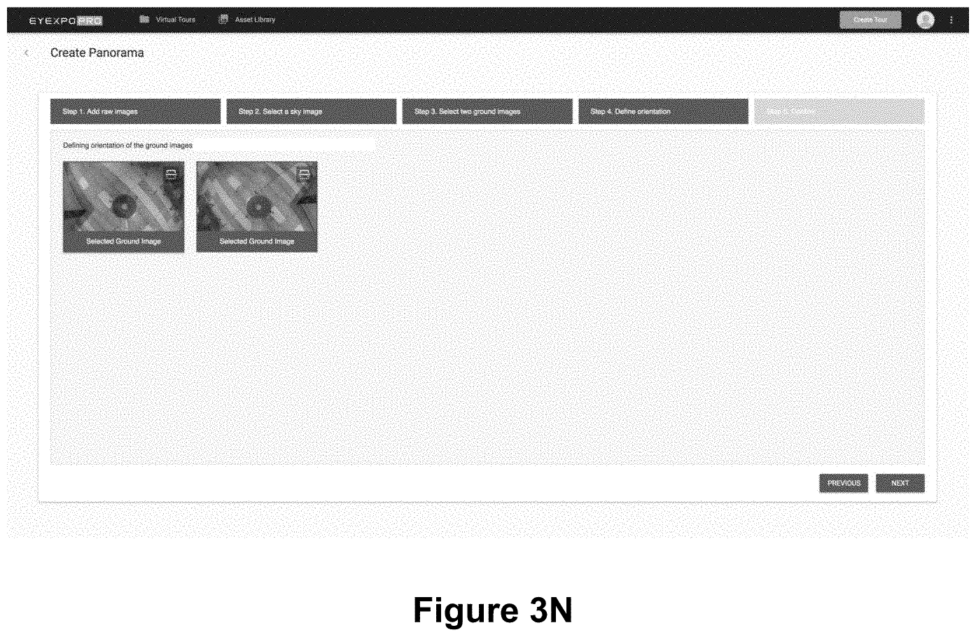

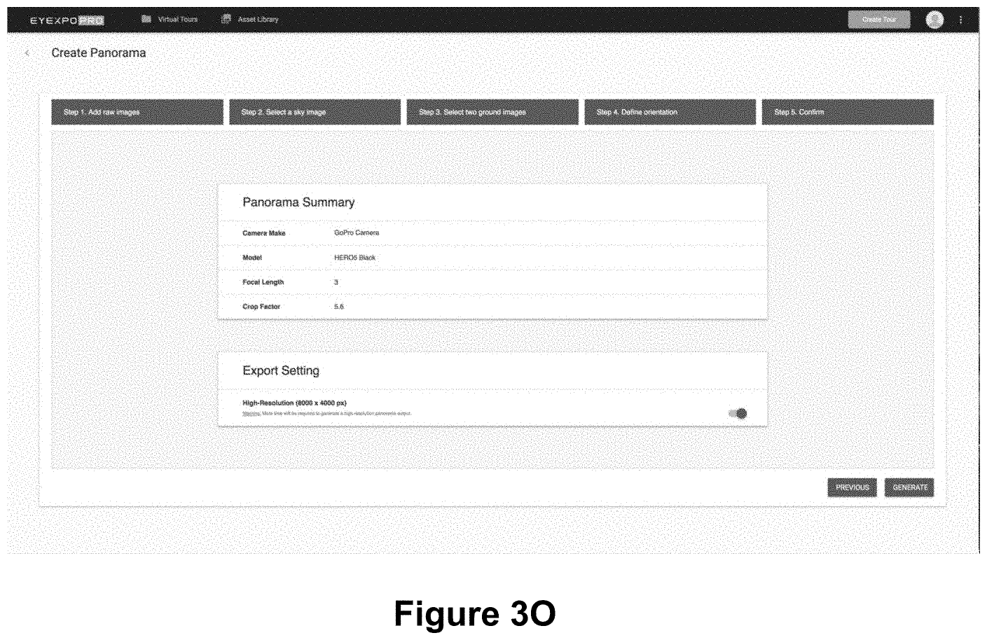

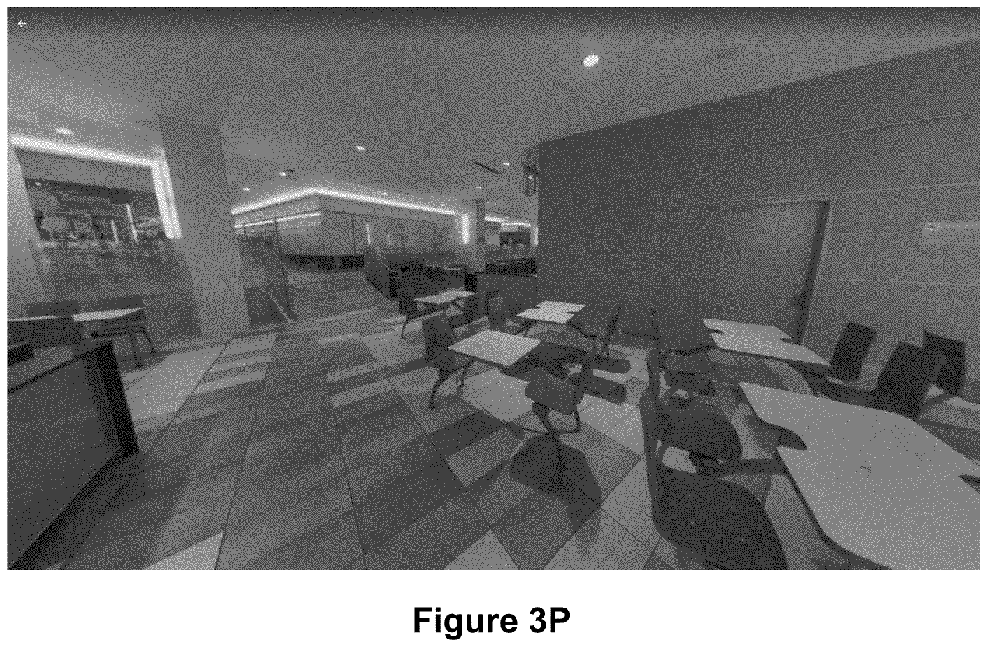

FIG. 3A is an example of a scene menu which shows the panorama images as part of a virtual tour, according to an embodiment of the disclosure.

The content creator is provided with the ability to create 206 a virtual tour with one or more panorama images. The panorama image used to create the virtual tour can be an existing 360 panorama image stored in the asset library 218 with the user account or uploaded from a local computer, or can be created by stitching a plurality of images uploaded by the content creator. The uploaded and/or generated 360 panorama images, as well as 3D models and 3D photos, can be stored in the asset library 218.

FIG. 3B is an example of the asset library 218 which stores 360 panorama images, 3D models and 3D photos, according to an embodiment of the disclosure.

When a virtual tour is to be created 206, the user can be prompted to identify 208 whether one or more panorama images exist for creation of the virtual tour. Depending on whether panorama images exist, the virtual tour can be built on one or more existing panorama images (“Yes”); or the process will proceed to panorama image creation (“No”).

If the answer to step 208 is yes, at step 210, existing panorama images can be retrieved from the asset library 218 or uploaded from a local computer. To build one virtual tour, one or more panorama images can be selected 212. Once one or more panorama images are selected for building the virtual tour, the content creator is prompted to enter the “Editor” page 214 which presents the content creator with various functionality to build and edit the virtual tour with.

In various embodiments, the virtual tour builder allows the content creator to include interactive user interface/user experience (UI/UX) elements or models, where the content creator is allowed to edit and customize the generated virtual tour. The embedded elements or models can be in 2D or 3D. In some embodiments, a virtual tour can be enhanced by allowing the user to perform editorial tasks such as adding a hotspot, connecting to a different view, embedding multimedia contents, embedding 3D models, embedding Google™ maps, or the like.

In some embodiments, the virtual tour builder provides preset widgets which can be used easily by the content creator. In order to activate these functions, the content creator can simply drag and drop a selected template into the VR environment view.

According to some embodiments of the disclosure, the content creator can be provided with a widget to add one or more 2D hotspots. The content creator can drag and drop each hotspot onto a panorama scene to add text, images and/or hyperlinks to external URLs. A hotspot can be generated when the user clicks on a hotspot button, and the user can drag it to adjust its position in the virtual tour.

In some embodiments, the virtual tour can also be edited by the user defining at least one region in the virtual tour or associating a hotspot with the defined region. When the user defined region is activated (by way of, for example, moving the cursor into the defined region, or by pressing the defined region), a corresponding function can be activated, such as connecting to a different view, playing an audio or video content, or displaying a picture.

The UI/UX can be designed to fit naturally in the 3D space of the VR environment. When the UI/UX designs are in two dimensions, a mathematical 2D to 3D coordinate transformation will be performed to provide a clear and natural visual cue of where the UI/UX design is located within the 3D space. For example, the sphere of the 3D space of the VR environment can have a fixed radius, and each hotspot has its 2D coordinates on the editor window. The projective transformation can be calculated using the Pythagorean Theorem to transform the 2D designs within the 3D space to avoid them from looking visually out of place. The interactive information, elements and/or items can be allocated to proper locations and converted into presentation forms suitable in a curved spherical environment.

In some embodiments, the content creator can also add one or more teleports to link one scene with one or more scenes. The destination scenes can be dragged and dropped in the current scene. Each teleport acts as an access to move from the current scene to each of the one or more destination scenes. The builder may provide a default view direction for entering a destination scene, so viewers will not lose the direction teleporting between scenes.

In some embodiments, the content creator can also set background music to play for the virtual tour experience. The background music can be selected from a provided list of royalty free music or uploaded using user's own MP3 tracks. The content creator can also edit tour settings including adding a tour title, descriptions and/or a location for display (e.g., by embedding a Google map), either in the preview mode, or the VR mode. Users are also able to add a scene title to a scene of the virtual tour. The content creator may also add a contact number such as a phone number to the virtual tour so the user can click on a button in the created virtual tour and direct dial the contact number through an associated phone service.

The virtual tour builder according to various embodiments also provide content creators with a set of tools allowing them to add 3D elements or models into the virtual tour so that these embedded 3D elements or models can be viewed and experienced in the VR mode with VR headsets or goggles.

According to some embodiments of the disclosure, the content creator can be provided with a widget to embed one or more interactive 3D elements, objects or assets into the virtual tours. These embedded 3D objects, when viewed in the VR mode with a VR headset or goggle, are controllable by the user through control elements or interface associated with the VR headset or goggle. In one implementation, the embedded 3D models are in the glTF format and are embedded into the virtual tour as part of an Aframe layer.

In some embodiments, the content creator can also add one or more 2D hotspots which support embed codes, where users can embed one or more codes that retrieve 3D content outside of the virtual tour builder for displaying within the virtual tour when viewed with a VR headset or goggle. For example, the embedded code can include but not limited to a URL to a 3D photography work. Embedded codes are in the form of HTML codes and they are embedded into a virtual tour as an Aframe layer, to retrieve content from another website to display in, for example, a sub browser window that will appear in the virtual tour.

In some embodiments, the content creator can also add 3D text in a virtual tour. The virtual tour builder supports different character types, such as English, Chinese, etc. Users can add 3D text into the virtual tour environment that will render in the WebVR mode.

The virtual tour builder or “Editor” leverages the core Aframe.io framework, which is fully HTML based. The virtual tour builder according to various embodiments of the disclosure accepts 3D models of the file type glTF/GLB and embed them into the 360 panorama image, where the glTF/GLB file format serves as the standard file format for 3D scenes and models using the JavaScript Object Notation (JSON) standard. The 3D models and photos can also be stored in the asset library 218.

Within the virtual tour “Editor” page 214, the content creator is also able to directly add a panorama image from the library 218 or upload one from their local computer to one virtual tour. The content creator is also able to remove a panorama image from the virtual tour.

FIG. 3C is an example of the “Editor” page 214 user interface, according to an embodiment of the disclosure. On the Editor page 214, a number of widgets 300 are shown including a button 302 for adding a hotspot; a button 304 for embedding a 3D model; a button 306 for setting the background music and its mode; and a button 308 for adding a contact number.

FIG. 3D is an example of the user interface for adding a hotspot to a scene of a virtual tour, according to an embodiment of the disclosure. The content creator can drag the hotspot to adjust its position in the virtual tour.

FIG. 3E is an example of the user interface for adding a teleport to link a different scene with the current scene and setting a default view, according to an embodiment of the disclosure.

FIG. 3F is an example of the user interface for embedding a 3D model to a scene of a virtual tour, according to an embodiment of the disclosure. In this example, the 3D model is a guitar rotatable in 3D. The scene with the embedded 3D model can either be previewed in the 2D web browser mode, or the WebVR mode, by pressing the button 310. FIG. 3G is an example of adjusting the settings of the 3D model, according to an embodiment of the disclosure.

FIG. 3H is an example of the virtual tour with the embedded 3D model in preview mode, according to an embodiment of the disclosure. From the preview page, the user can press a button 312 to view the virtual tour in WebVR mode, as shown in FIG. 3I. When the virtual tour is in the WebVR mode, the user can place the computing device (e.g., a mobile phone) into a supporting VR device or goggle and view the virtual tour in three dimensions. As can be seen, the 3D object rotatable guitar is maintained in the WebVR and VR mode.

FIG. 3J is an example of the user interface allowing the content creator to add one or more panorama images to the virtual tour, according to an embodiment of the disclosure.

The “Editor” 214 can autosave changes when the content creator is editing a virtual tour. In particular, any changes made can be automatically saved within a specific interval and upon exiting the “Editor”.

As already illustrated, the created virtual tour can be previewed in a 2D web browser environment. The preview can be done in a separate browser tab from the “Editor” tab. Alternatively, the preview and editing mode can be inter-changed within a single browser view. Only users that have permissions to that virtual tour are able to preview the virtual tour.

Referring back to FIG. 2, at step 208, when the user identifies that no panorama image exists for creating the virtual tour, the process proceeds to the flow of creating 220 a 360 panorama image. The virtual tour builder allows users to create a 360 panorama image by uploading 222 original photos taken from a supporting device such as a Go Pro device. In one implementation, the virtual tour builder can support uploading and stitching of photos each below e.g., 15 MB in size.

For preparation of stitching and will be explained in more detail below, users will prompted to select 224 an image of the sky from the plurality of uploaded images; select 226 one or more images of the ground from the plurality of images; and set 228 the orientation of the one or more ground images. Users can optionally set 230 the details and resolutions for stitching, and execute 232 the stitching so that the plurality of images will be combined into a 360 panorama image, based on the selections and settings.

FIG. 3K is an example of the user interface for adding the images for stitching, according to an embodiment of the disclosure. In this example, at least 8 images may be requested for stitching of one panorama image. FIG. 3L is an example of the user interface for selecting a sky image to ensure the proper orientation of the stitched panorama image. FIG. 3M is an example of the user interface for selecting one or more ground images. In this example, two images of the ground may be requested to ensure that the panorama image created does not display the supporting tripod. FIG. 3N is an example of the user interface for identifying the orientation of the ground images to help remove the tripod. FIG. 3O is an example of the user interface for providing the specifications of the panorama stitching. FIG. 3P is an example showing the stitched panorama image, based on the above selections.

After one panorama image is created, the process can continue to create 234 another panorama image. As described above, all created panorama images are saved in the asset library 218. The asset library 218 stores a list of all panorama images that exist for the logged-in user and those have been used in one or more VR Tours. Users are able to preview, edit, download and delete the panorama images within the asset library 218. For example, image saturation levels, white balance, exposure, and/or brightness, etc., can be edited for panorama images that have been uploaded and/or created. The adjustments to the original panorama images can be saved.

The virtual tour builder according to various embodiments builds and improves upon the technology stack Hugins, which is a library that serves as the underlying technology to produce 360 panorama images from a set of original photos uploaded by content creators.

The Hugins process of creating a panorama image includes over 20 internal operations that need to be called separately with input parameters where the next operation relies on the previous operation's output. In order to make the serial process Cloud-friendly, the Cloud-based solution includes a queuing system that transformed the original design of the library to a parallel processing approach scaling each of the 20 steps.

Accordingly, the stitching process is an asynchronous process where the users do not need to wait for the process to be done before performing other functions.

Users will be notified when the panorama image creation process is completed or failed. The notification can be provided in the web browser, and/or through an email or SMS.

As will be explained in detail below, the virtual tour builder processes a sky image, a ground image, or both differently from the balance of the images. In one implementation of the disclosure, the sky image and/or the ground image are identified by the user. The identified sky image and ground image can be used as anchor points for aligning the images in image stitching.

The systems and methods disclosed herein may be used in connection with cameras, lenses and/or images. For example, the plurality of images can be captured by an external digital camera, a smartphone built-in camera, or a digital single-lens reflex (DSLR) camera. A normal lens may produce normal images, which do not appear distorted (or have only negligible distortion). A wide-angle lens may produce images with an expanded Field of View (FoV) and perspective distortion, where the images appear curved (e.g., straight lines appear curved when captured with a wide-angle lens). The captured images are typically taken from the same location and have overlapping regions with respect to each other. The images can be a sequence of adjacent images captured by the user scanning the view using the camera while self-rotating with respect to a center of rotation, or by a rotating camera. In one example, the plurality of images can be taken by a Go Pro device. In many cases, the capturing of the images may be assisted with a supporting tripod.

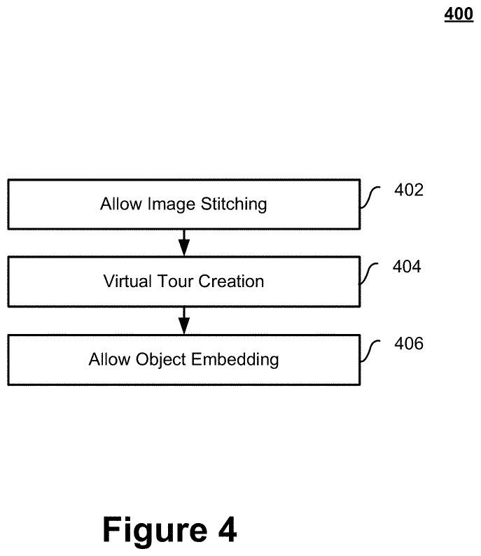

FIG. 4 is a cloud-based method 400 of creating a virtual tour, according to one embodiment of the disclosure. At step (402), a user or content creator is enabled to upload images for stitching of a 360 panorama image. A virtual tour is created (404) based on the 360 panorama image; and the user is allowed (406) to edit the virtual tour by embedding an object for the user to interact with, when the virtual tour is viewed with a VR headset.

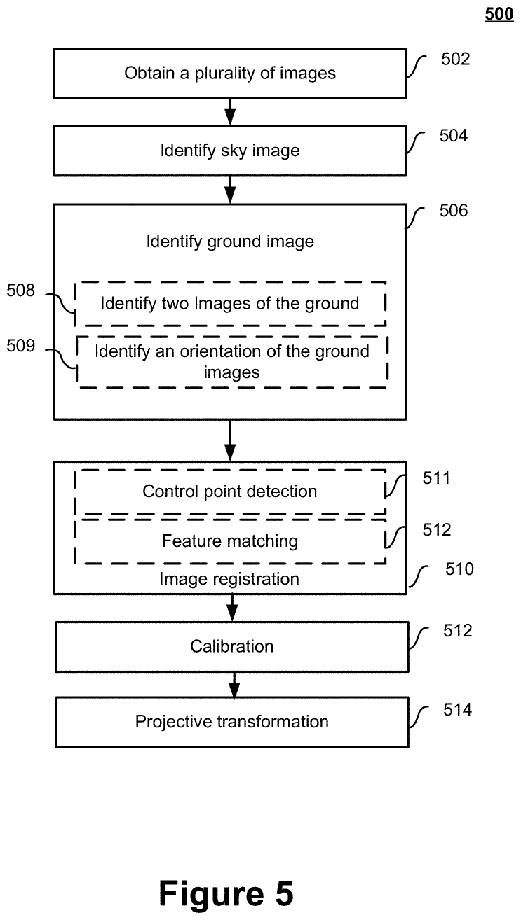

FIG. 5 is a cloud-based method 500 of 360 panorama image stitching, according to one embodiment of the disclosure.

According to the embodiment, the system first obtains (502) a plurality of images to be used for image stitching. The images can be solicited from the user, by prompting the user to upload the images to the Cloud. The user can retrieve the image files locally or remotely. For image stitching, the ideal set of images has a reasonable amount of overlap with respect to each other which can be used to overcome lens distortion and which have enough detectable features. In one implementation of the disclosure, the user is prompted to select 8 images that cover the range of the 360 degree FoV for the stitched image.

Once the images are uploaded, an image of the sky will be identified (504) from the uploaded images and subsequently or concurrently one or more images of the ground will also be identified (506). The user can be prompted to make a first selection of the sky image from the uploaded images and a second selection of the ground image(s). In one embodiment, the identification of the ground image(s) includes an identification (508) of two images of the ground. The user will also be prompted to make an identification (509) of an orientation of each of the two ground images. By making sure the orientation of the two ground images are aligned, the method helps Hugins determine the exact location of the tripod, which then will allow the application of a patch or image on top of the tripod to cover it in the panorama image thereby removing the tripod stick.

Once the system receives the user's selections, a job will be established and pushed to the processing queue. The queue will then execute the job based on its priority and its order within the queue.

The virtual tour builder will first perform image registration (510) which is a two-step process including control point detection (511) and feature matching (512).

Image registration (510) is the process of transforming different sets of pixel coordinates of the different images into one coordinate system. Control point detection (511) creates a mathematical model relating to the pixel coordinates that the system can use to determine whether two images have any overlapping regions, and to calculate the transformation required to align them correctly. Feature matching (512) finds the minimal sum of absolute differences between overlapping pixels of two images and aligning them side by side.

Most existing solutions on the market use scale-invariant feature transform (SIFT) or speeded up robust features (SURF) detectors, but the downside of these two algorithms are that they do not perform well when an image has a minimal amount of features, such as in the case when the image contains the sky and/or the ground. Sky images and ground images are generally composed of extremely similar pixels, hence they have the least amount of control points. Accordingly, even when conventional methods complete the image stitching, the stitched image may end up being tilted. In some cases, a line not associated with the horizon may be recognized as the horizon line, and consequently the constructed 3D space will be twisted; or in some other cases, an image of the sky may be recognized as an image of the ground, and vice versa, which subsequently results in a stitched image with the sky and the ground in opposite positions. This could be caused by the system recognizing the correct horizon line, but failing to recognize what is above the horizon line, and what is below the horizon line.

The virtual tour builder according to various embodiments reduces such visual artifacts and improves upon the accuracy of image stitching by identifying a sky image and at least one ground image separate from the balance of the images, and using the identified images as anchors for alignment.

The virtual tour builder according to various embodiments also provides two modes of image stitching. The first mode is cylindrical panorama stitching where the system performs a cylindrical projection of the series of images into the three-dimensional space; and the second mode is spherical panorama stitching where system performs a spherical projection of the series of images into the three-dimensional space. A spherical panorama provides a larger and more complete FoV than a cylindrical panorama.

In one embodiment, if the user has made a selection during the creation of the job, then the system can proceed in the spherical panorama stitching mode to process the sky image and the ground image separately. If the user has selected neither of them, the system would assume that the user would like to obtain a cylindrical panorama image and will proceed in the cylindrical panorama stitching mode and process all images equally.

After the system has calculated (511) the control points of all images, the system will perform the feature matching process (512). The virtual tour builder according to various embodiments builds and improves upon the Hugins algorithm, but processes the sky image and the ground image differently. The identified sky image will be projected to an upper most portion of the three-dimensional space, and the identified ground image will be projected to a lower most portion of the three-dimensional space. The other images will be aligned downwards from the identified sky image, and upwards from the identified ground image. In other words, the identified sky image and/or ground image are used as anchor points for aligning the other images. When there are multiple sky images or multiple ground images, the identified sky image is used to recognize other sky image(s) and the identified ground image is used to recognize other ground image(s). The virtual tour builder then performs image stitching for the rest of the images. Because the sky image is usually at the upper most portion of the image view, all sky images will be placed at the top of the stitched image, and the subsequent alignment will proceed downwards from the sky images. Similarly, because the ground image is usually at the lower most portion of the image view, all ground images will be placed at the bottom of the stitched image, and the subsequent alignment will proceed upwards from the ground images. For example, if the sky image contains a top of a house, when the sky image is placed at the top of the image view, the other image alignment can be facilitated by recognizing the other portion of the house to be aligned downwards from the sky image. This drastically reduces the number of iterations required to perform the alignment task and produces more accurate stitching result. Feature matching (512) generates a transform matrix for transforming the series of images into a new coordinate system and the transform matrix will be used subsequently to align the images accurately.

After image registration (510), the system will perform calibration (512) to minimize the differences between the series of images in terms of lens difference, distortions, exposure and etc.

When the user creates a job, the user may be prompted to identify the lens type used for capturing the images, for example, as either a normal lens or a fisheye lens. This information helps to perform necessary transformation for each image to match the viewpoint of the image that is being composed to. The virtual tour builder calculates the amount of adjustment that each pixel coordinate of the original image required to match with the desired viewpoint of the output stitched image, and the calculated result will be stored in a matrix called homography matrix. For normal lens, because the captured images involve little distortion, the calibration process generally involves mapping the 2D images to the 3D spherical space in a natural manner. For fisheye lens, because the captured images also involve spherical distortion, the system may only adjust for their colors or exposures. The adjustment can be based on for example, an average sampling, to avoid over or under exposure of the stitched image.

The stitched image will then be generated by executing a projective transformation from the original images. The projective transformation involves the previously calculated transform matrix, homography matrix, and further includes color adjustments to blend the images seamlessly. Once completed, the user can be notified and provided with the stitched image.

After the stitched image has been generated, the stitched image can be rendered into a VR environment view by for example, the user importing the stitched image into a virtual tour in the virtual tour builder.

The virtual tour builder according to various embodiments increases the accuracy of image stitching by identifying and processing the sky image and the ground image separately. The stitched images created by the tool are shown to have a much reduced appearance of tilting. To generate stitched images of similar qualities, conventional methods would require a manual alignment or user manipulation of the image view. For users without experience in image processing, it is very difficult to align the horizon line to a straight and correct position, or at least it takes them a great amount of effort and time to do so. By aligning the images based on the sky image and the ground image, the virtual tour builder can free the users from manual manipulation and improve the accuracy of image stitching. The virtual tour builder according to the embodiments can produce reliable results with reduced computing complexity and improved processing speeds.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and as set forth in the attached claims.

1. A Cloud-based method of creating a virtual tour, comprising:
creating a virtual tour based on a 360 panorama image; and
allowing a user to edit the virtual tour by embedding an object for the user to interact with, when the virtual tour is viewed with a Virtual Reality (VR) headset,
wherein the object is a 3D object.

2. The Cloud-based method according to claim 1, further comprising:
allowing the user to upload a plurality of images to the cloud;
prompting a first identification of an image of the sky from the plurality of images;
prompting a second identification of an image of the ground from the plurality of images;
stitching the plurality of images into a 360 panorama image, based on the first and second identifications; and
rendering the 360 panorama image into a VR environment view.

3. The Cloud-based method according to claim 2, wherein prompting the second identification of the image of the ground from the plurality of images comprises:
prompting an identification of two images of the ground; and
prompting an identification of an orientation of each of the two ground images.

4. (canceled)

5. The Cloud-based method according to claim 1, wherein the 3D object is in a form of a GL Transmission Format (glTF) file.

6. The Cloud-based method according to claim 1, wherein the 3D object is a 3D text.

7. The Cloud-based method according to claim 1, wherein the virtual tour is built on an A-frame.io framework.

8. The Cloud-based method according to claim 7, wherein the object is a 3D object and the 3D object is embedded into the virtual tour as part of an A-frame layer.

9. The Cloud-based method according to claim 2, wherein stitching the plurality of images into a 360 panorama image is performed using Hugins.

10. The Cloud-based method according to claim 1, further comprising displaying the virtual tour in a web browser.

11. The Cloud-based method according to claim 1, wherein the embedded object is interactive based on controls associated with the VR headset when the virtual tour is viewed with the VR headset.

12. The Cloud-based method according to claim 9, wherein stitching the plurality of images into a 360 panorama image is based on a queuing system that transforms the stitching as a parallel processing.

13. A non-transitory computer readable memory recorded thereon computer executable instructions that when executed by a processor perform a Cloud-based method of creating a virtual tour, comprising:
creating a virtual tour based on a 360 panorama image; and
allowing a user to edit the virtual tour by embedding an object for the user to interact with, when the virtual tour is viewed with a Virtual Reality (VR) headset,
wherein the object is a 3D object.

14. The Cloud-based method according to claim 1, further comprising adding a teleport to link one panorama image of the virtual tour with one or more other panorama images.

15. The Cloud-based method according to claim 1, further comprising adding a hotspot to one panorama image.
